(19) United States
(12) Patent Application Publication
(10) Pub. No.: US 2021/0079955 A1
(43) Pub. Date: Mar. 18, 2021

(54) SPHERICAL DEVICE PROVIDED WITH CONVEX SPLINES FOR FORMING A BALL-AND-SOCKET JOINT HAVING A FINGER, AND WOBBLE PUMP PROVIDED WITH SUCH A DEVICE

(71) Applicant: IFP Energies nouvelles, Rueil-Malmaison (FR)

(72) Inventors: Jean TRICARD, PARAY VIEILLE POSTE (FR); Julien TROST, PARIS (FR); Philippe PAGNIER, SAINT CLAIR DU RHONE (FR)

(21) Appl. No.: 16/756,998

(22) PCT Filed: Oct. 8, 2018
(86) PCT No.: PCT/EP2018/077340

§ 371 Date: Nov. 30, 2020

(30) Foreign Application Priority Data
Oct. 20, 2017 (FR) 1759900

(51) Int. Cl. F16D 3/18; F16D 3/224

(52) U.S. Cl. CPC F16D 3/185; F04B 1/146; F16D 3/224

(57) ABSTRACT

The present invention relates to a device for forming a pin spherical joint. Device (10) comprises a cylindrical inner surface (11). The device comprises an outer surface (12) having the shape of a truncated sphere at its ends. According to the invention, inner surface (11) comprises at least one groove (14) or a spline. Furthermore, outer surface (12) comprises at least one crowned spline (13). The invention further relates to a connection between a shaft and a plate with such a device, and to a barrel pump equipped with same.

### FIELD OF THE INVENTION

The present invention relates to the field of pin spherical joints, in particular for use in a barrel pump.

A pin spherical joint is a link between two mechanical elements having four degrees of linkage and two degrees of relative motion; only two relative rotations are possible, the three translations and the last rotation being linked. Generally, it is a spherical joint provided with a pin hindering rotation. The operating principle of this type of link consists in providing torque transmission between two rotating assemblies whose axes are not colinear. For example, in the case of a barrel pump, it can be a link between the drive shaft and the rotary plate.

### BACKGROUND OF THE INVENTION

Today, there are two main types of pin spherical joints:
universal joints (or cardan joints) (FIG. 1) enable very high torque transmission, but with a relatively small angular displacement (around 20 degrees). They are also relatively bulky. Universal joints are the most commonly used pin spherical joint mechanisms in mechanical systems, for example in the automotive sector. FIG. 1 illustrates an example of a double universal joint in two distinct positions. The universal joint comprises two sleeves 1 and 3 at its ends, and a shaft 2 arranged between sleeves 1 and 3. A coupling 4 is assembled between sleeve 1 and shaft 2. Similarly, a coupling 5 is assembled between shaft 2 and sleeve 3. Each coupling 4 and 5 has two yokes and a spider (not shown), so as to enable relative motion of the parts. The angular displacement α is low, of the order of 20°;
ball joints (FIG. 2) are very compact and they enable angular displacements exceeding 50 degrees. However, the transmissible torques are lower than with universal joints and, besides, assembly and implementation thereof (lubrication for example) are relatively complex. FIG. 2 illustrates an example of a ball joint. The ball joint allows connection between a shaft 6 and a shaft 8. The ball joint comprises a substantially spherical raceway 7 wherein balls 9 circulate.

Patent application WO-2017/051,710 discloses a pin spherical joint with an interesting angular amplitude. However, the complexity of the mechanism is significant, and the transmissible torque relatively low.

Moreover, there are other examples of this type of link for low rotational speed and low torque applications, which are not suited to high torques and/or high rotational speeds.

In order to overcome these drawbacks, the present invention relates to a device for forming a pin spherical joint. The device comprises a cylindrical inner surface for mounting on a shaft. The device comprises an outer surface having the shape of a truncated sphere at its ends. According to the invention, the inner surface comprises at least one groove or one spline for inserting a key for torque transmission between a shaft and the device. Furthermore, the outer surface comprises at least one crowned (or curved) spline for torque transmission between the device and a component, notably a plate or a disc. This specific shape (spherical shape with at least one spline) provides the pin spherical joint and it enables high torque transmission, as well as a significant angular displacement.

### SUMMARY OF THE INVENTION

The invention relates to a device for forming a pin spherical joint in form of a hollow revolution part comprising a substantially cylindrical inner surface and an outer surface having substantially the shape of a truncated sphere at both ends. Said inner surface comprises at least one groove and said outer surface comprises at least one crowned spline.

According to an embodiment, said outer surface comprises a plurality of evenly distributed crowned splines.

Advantageously, said outer surface comprises between five and nineteen crowned splines, preferably between seven and thirteen crowned splines.

According to an implementation, said crowned splines have a substantially square, rectangular or trapezoidal section.

According to an aspect, said device consists of a monobloc piece.

According to a feature, said device is made of metal, notably a ferrous alloy, preferably steel.

Advantageously, according to an axial cutting plane of said device, the angle β formed by two ends of said outer surface of said device and the centre of said sphere ranges between 60° and 120°, notably between 80° and 100°, and angle β is preferably 90°.

Furthermore, the invention relates to a connection between a shaft and a plate. A device for forming a pin spherical joint according to one of the above features is mounted on said shaft by means of at least one key or a splined shaft, and said plate is mounted on said outer surface of said device so as to form a pin spherical joint by means of at least one groove cooperating with said at least one crowned spline.

Advantageously, said plate comprises at least one means forming an angular stop.

The invention further relates to a barrel pump with a rotary plate comprising a connection according to one of the above features for linking a drive shaft and said rotary plate.

The invention also relates to a use of said barrel pump according to one of the above features for a drilling operation, in particular for drilling mud injection.

### BRIEF DESCRIPTION OF THE FIGURES

Other features and advantages of the device according to the invention will be clear from reading the description hereafter of embodiments given by way of non-limitative example, with reference to the accompanying drawings wherein:

FIG. 1, already described, illustrates a universal joint according to the prior art,

FIG. 2, already described, illustrates a ball joint according to the prior art,

FIG. 3 illustrates a device for forming a pin spherical joint according to an embodiment of the invention,

FIG. 4 illustrates a sectional view of a device for forming a pin spherical joint according to an embodiment of the invention, and

FIG. 5 illustrates a pin spherical joint between a shaft and a plate according to an embodiment of the invention.

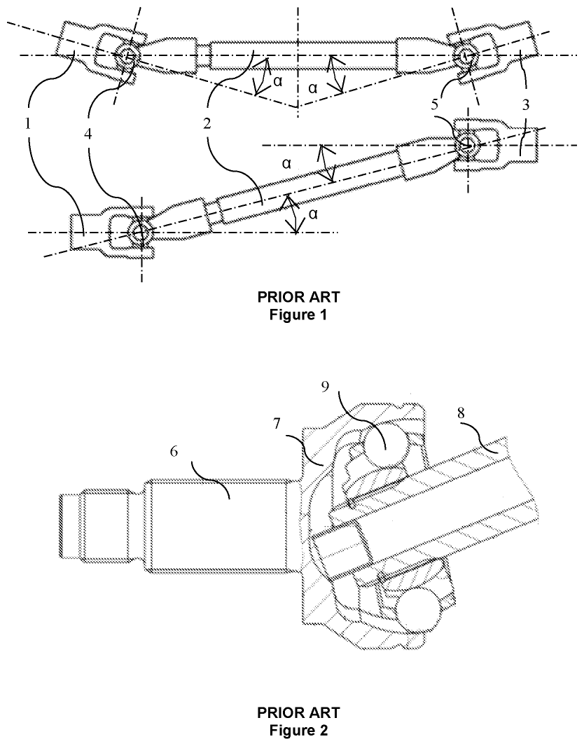

### DETAILED DESCRIPTION OF THE INVENTION

The present invention relates to a device for forming a pin spherical joint. A pin spherical joint is a link between two mechanical elements having four degrees of linkage and two degrees of relative motion; only two relative rotations are possible, the three translations and the last rotation being linked. Generally, it is a spherical joint provided with a pin hindering rotation. The operating principle of this type of link consists in providing torque transmission between two rotating assemblies whose axes are not colinear.

For clarity of the description, the term “device” is used in the rest of the description below to designate the device for forming a pin spherical joint.

According to the invention, the device for forming the pin spherical joint is a hollow revolution part. It is reminded that, in geometry, a revolution part is a part generated by a closed plane surface rotating about an axis located in the same plane and having no point in common therewith, or only boundary points.

The device for forming the pin spherical joint comprises a substantially cylindrical inner surface. Thus, the hollow part of the device is substantially cylindrical. The device is therefore suited to be mounted on a cylindrical shaft. The inner surface comprises at least one groove for inserting a key or a splined shaft (in case of a plurality of splines), so as to transmit the torque between a shaft and the device. Using a key or spline transmission enables high torque transmission.

The device according to the invention comprises an outer surface having substantially the shape of a truncated sphere at both ends. The sphere is truncated by two planes perpendicular to the axis of revolution of the device. This partly spherical shape of the outer surface provides a spherical joint. Furthermore, the outer surface comprises at least one crowned (or curved) spline. The crowned spline allows, on the one hand, to form the pin of the pin spherical joint and, on the other hand, to provide large torque transmission between the device and an element positioned on the outer surface of the device (a plate or a disc for example).

This design of the device for forming a pin spherical joint provides high compactness, large angular displacement and simplicity of use.

Advantageously, the groove and the spline(s) are parallel to the axis of revolution of the device.

Preferably, the spline(s) have a crowned (or curved) shape parallel to the globally spherical shape of the outer surface of the device. Thus, the splines may be involute splines so as to have the greatest transmissible torque.

According to an aspect of the invention, the outer surface comprises a plurality of crowned splines evenly distributed over the circumference of the spherical surface. A higher torque can thus be transmitted between the device according to the invention and the element positioned on the outer surface of the device. The splines are preferably parallel to one another. For example, the outer surface of the device can comprise between five and nineteen crowned splines, preferably between seven and thirteen, in order to optimize the manufacture of the device and the torque transmissible thereby, and to optimize the distribution of forces in the splines.

In order to provide good mechanical strength to the crowned splines, the splines can have a substantially rectangular, substantially square or substantially trapezoidal section. The splines can have fillet radii preventing stress concentration.

Advantageously, the device according to the invention can be symmetrical with respect to a plane perpendicular to the axis of revolution thereof. Thus, the device is easy to manufacture.

According to a feature of the invention, the groove can have a substantially rectangular section. It is thus possible to easily use a substantially parallelepipedic key for torque transmission.

In order to simplify assembly and manufacture of the device according to the invention, the device can consist of a monobloc piece.

Advantageously, the device according to the invention can be made of metal, notably a ferrous metal alloy, steel for example, so as to have sufficient strength to transmit high torques.

The device according to the invention can be obtained by machining, moulding, additive manufacturing, or any similar method.

According to a non-limitative example embodiment, the device according to the invention can have at least one of the following dimensions:
the ratio of the diameter of the sphere to the length of the device along the axis of revolution can range between 1 and 2, preferably between 1.4 and 1.6, and it may be 1.45 for example,
the sections of the groove and the key can depend on the diameter of the inner surface and on the torque to be transmitted,
the section of the crowned splines can have dimensions ranging between 300 and 1000 mm², more specifically between 500 and 700 mm².

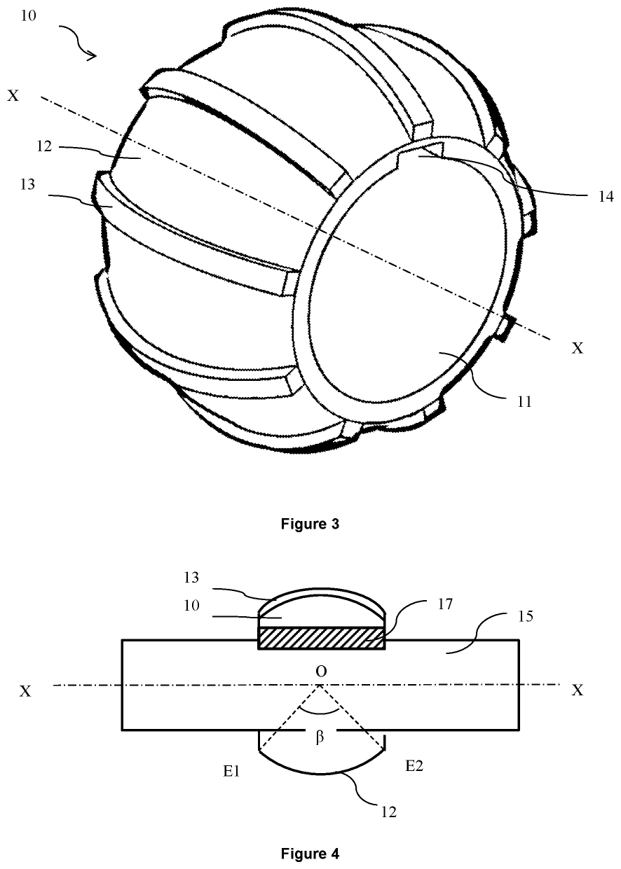

FIG. 3 schematically illustrates, by way of non-limitative example, a device for forming a pin spherical joint according to an embodiment of the invention. Device 10 is a revolution part rotating about axis XX. Device 10 is hollow and it comprises a cylindrical inner surface 11. Inner surface 11 comprises a groove 14. The section of groove 14 is substantially rectangular. Device 10 comprises an outer surface 12 having substantially the shape of a truncated sphere at both ends, the truncation being achieved at two planes perpendicular to axis XX. Outer surface 12 comprises a plurality of crowned (curved) splines 13, in the case illustrated here, nine crowned splines 13. Crowned splines 13 have an outer surface substantially parallel to outer surface 12 of the device. These splines 13 are involute splines.

According to an embodiment of the invention, in an axial cutting plane of said device (plane including the axis of revolution), the angle β formed by two ends of the outer surface of the device according to the invention and the centre of the sphere (corresponding to the outer surface) can range between 60° and 120°, more specifically between 80° and 100°, and it is preferably substantially 90°. This angle provides a large spherical joint surface area and it therefore enables a great angular displacement, for example of the order of 40°.

FIG. 4 schematically illustrates, by way of non-limitative example, the assembly of a shaft 15 with a device 10 for forming a pin spherical joint according to an embodiment of the invention. FIG. 4 is a sectional view along an axial cutting plane (plane including axis of revolution XX) of this assembly. In this figure, only one crowned spline 13 is shown. Shaft 15 is mounted in device 10 by means of a key 17. In the figure, point E1 corresponds to a first end of outer surface 12 of device 10, point E2 corresponds to a second end (opposite the first end) of outer surface 12 of device 10, and point O corresponds to the centre of the sphere of outer surface 12. The angle β formed by points E1, O and E2 is substantially 90°.

Furthermore, the invention relates to a connection between a shaft and a plate (or disc) for example. This connection is a pin spherical joint. The connection is achieved by the device for forming a pin spherical joint according to one of the above combinations of features. Thus, for this connection, the device for forming a pin spherical joint is mounted on the shaft by means of at least one key. Furthermore, the plate is mounted on the outer surface of the device so as to form a pin spherical joint by means of at least one groove cooperating with the crowned spline(s).

With the invention, a pin spherical joint is formed between the shaft and the plate: the plate can rotate by means of the spherical outer surface of the device, and the torque can be transmitted from the shaft to the plate by the key or by the crowned spline(s).

This link is here a non-slip constant-velocity spherical joint, which means that the rotational speed at the joint input is identical to the rotational speed at the joint output, and this connection occurs without slip but through direct mechanical drive.

This design of the connection enables a pin spherical joint link providing high compactness, large angular displacement and simplicity of use.

To achieve the pin spherical joint, the plate can comprise a substantially spherical inner surface.

In order to facilitate assembly of the connection, the plate can consist of two half-shells. Alternatively, the plate can be made of a single piece.

According to an aspect of the invention, the plate (or disc) can comprise a means forming an angular stop. It can be a surface coming into contact with the shaft; for example, the plate can comprise a conical inner surface coming into contact with the shaft for the maximum angular displacement.

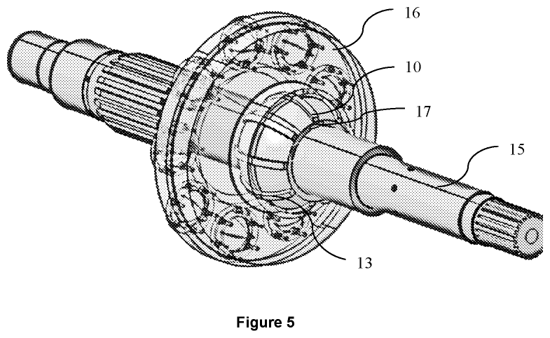

FIG. 5 schematically illustrates, by way of non-limitative example, the connection of a shaft 15 to a plate 16 by means of device 10 for forming a pin spherical joint as defined above. The device 10 shown corresponds to the embodiment of FIG. 3. Shaft 15 is mounted in device 10 by means of a key 17. Furthermore, plate 16 is mounted on device 10 by means of grooves (female splines) cooperating with crowned (curved) splines 13 of the outer surface of device 10.

Besides, the invention relates to a barrel pump with a rotary plate comprising a connection as defined above, between a drive shaft and the rotary plate.

The purpose of the barrel pump is to pump a fluid (for example water, oil, gas, drilling mud, etc.) through linear displacement of several pistons. This type of pump affords the advantage of being compact, of having interesting mechanical and volumetric efficiencies, as well as an excellent weight/power ratio. Furthermore, rotary barrel pumps are suited for high-pressure pumping.

The barrel pump according to the invention comprises a casing and it comprises within a casing:
a drive shaft driven in rotation relative to the casing by an external energy source, notably a prime mover (thermal or electric for example), in particular by means of a transmission (a gearbox for example),
a rotary plate driven by the drive shaft: the rotary plate is inclined in relation to the drive shaft; the inclination of the rotary plate generates an oscillating motion of the rotary plate; the rotary plate has a rotating motion and an oscillating motion in relation to the casing,
a cylinder block (referred to as barrel) comprising at least two circumferentially distributed (in other words, arranged in a circle) compression chambers (also referred to as sleeves), and
at least two pistons in translation respectively in the compression chambers, the pistons are driven by the rotary plate by means of connecting rods (the rods connect, through the agency of spherical joints, the rotary plate and the pistons so as to convert the oscillating motion to a translational motion of the pistons), and the translation of the pistons within the compression chambers generates pumping of the fluid.

According to the invention, the rotary plate is driven by the drive shaft by means of a pin spherical joint according to the invention, the position of the pin spherical joint determining the inclination of the rotary plate in relation to the drive shaft. For the invention, the pin of the spherical joint enables adjustment of the plate inclination in relation to the drive shaft. Indeed, the pump comprises means for controlling the pin spherical joint and therefore the inclination of the rotary plate in relation to the drive shaft.

Thus, the inclination of the rotary plate can be continuously adjusted, which enables variable displacement. Indeed, the inclination of the plate influences the stroke of the pistons. Furthermore, the pump according to the invention provides good flexibility through the continuous variation of the stroke volume. Besides, the pump according to the invention enables good reliability with the possibility of progressive pump start-up: for example, upon start-up, the angle of inclination can be small, and it can be increased thereafter depending on the desired conditions (fluid flow rate and pressure). This reliability cannot be obtained with a pump having a fixed inclination angle, or whose inclination cannot be continuously varied.

The plate can have substantially the shape of a disc. However, the plate can have any shape. Only the compression chambers (and the pistons) are arranged in a circle.

Advantageously, the pump according to the invention can comprise a number of pistons ranging between three and fifteen, preferably between five and eleven. Thus, a large number of pistons provides a continuous flow upstream and downstream from the pump.

Conventionally, the pump further comprises an inlet and an outlet for the fluid to be pumped. The fluid flows through the pump inlet into a compression chamber where it is compressed, then it is discharged from the pump through the outlet by the piston.

Moreover, conventionally, the pivot connections are made up of bearings or roller bearings promoting the relative motion of the elements.

Preferably, the cylinder block (or barrel) can be stationary in relation to the casing. Thus, the energy supply for pumping is performed at the drive shaft only, through the rotation thereof; the number of rotating parts is thus limited.

Alternatively, the cylinder block can also be rotary in relation to the casing. The advantage of this architecture is that the plate can be readily made adjustable in inclination, thus enabling variable displacement.

The invention also relates to the use of the pump according to the invention for a drilling operation, in particular for injecting drilling mud into a wellbore. Indeed, the pump according to the invention is well suited for this use due to its flexibility, compactness and high pressure strength.

For example, the pump according to the invention can be sized to operate up to pressures of the order of 1500 bar, i.e. 150 MPa. Besides, the pump according to the invention can be sized to operate at flow rates ranging from 30 to 600 m³/h.

1. A device for forming a pin spherical joint in form of a hollow revolution part comprising a substantially cylindrical inner surface and an outer surface having substantially the shape of a truncated sphere at both ends, wherein the inner surface comprises at least one groove or at least one spline, and in that the outer surface comprises at least one crowned spline.

2. A device as claimed in claim 1, wherein the outer surface comprises a plurality of evenly distributed crowned splines.

3. A device as claimed in claim 2, wherein the outer surface comprises between five and nineteen crowned splines, preferably between seven and thirteen crowned splines.

4. A device as claimed in claim 1, wherein the crowned splines have a substantially square, rectangular or trapezoidal section.

5. A device as claimed in claim 1, wherein the device consists of a monobloc piece.

6. A device as claimed in claim 1, wherein the device is made of metal, notably a ferrous alloy, preferably steel.

7. A device as claimed in claim 1 wherein, in an axial cutting plane of the device, the angle β formed by two ends of the outer surface of the device and the centre (O) of the sphere ranges between 60° and 120°, notably between 80° and 100°, and angle β is preferably substantially 90°.

8. A connection between a shaft and a plate, wherein a device for forming a pin spherical joint as claimed in claim 1 is mounted on the shaft by means of at least one key or a splined shaft, and in that the plate is mounted on the outer surface of the device so as to form a pin spherical joint by means of at least one groove cooperating with the at least one crowned spline.

9. A connection as claimed in claim 8, wherein the plate comprises at least one means forming an angular stop.

10. A barrel pump with a rotary plate comprising a connection as claimed in claim 8 for linking a drive shaft and the rotary plate.

11. Use of the barrel pump as claimed in claim 10 for a drilling operation, in particular for drilling mud injection.

12. A drilling operation, comprising injecting drilling mud using the barrel pump as claimed in claim 10.
